(19) United States
(12) Patent Application Publication
(10) Pub. No.: US 2004/0040831 A1
(43) Pub. Date: Mar. 4, 2004

(54) Method and apparatus for eliminating stench and volatile organic compounds from polluted air

(76) Inventors: Sung-Chang Hong, Seoul (KR); Yong-Gyu Kwon, Kyungki-do (KR)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/415,417

(22) PCT Filed: Nov. 6, 2001
(86) PCT No.: PCT/KR01/01884

(30) Foreign Application Priority Data
Nov. 6, 2000 (KR) 2000/65494

(51) Int. Cl. B01J 19/08

(52) U.S. Cl. 204/157.3; 422/186.3

(57) ABSTRACT

Disclosed are method and apparatus for processing stench and volatile organic compounds from a polluted air. Dust particles are removed from the polluted air. The stench of the polluted air and the volatile organic compounds are processed through a photooxidation reaction and an ozone oxidation reaction using an ozone generating UV lamp and a TiO₂-based photocatalyst. A residual ozone remaining after the photooxidation reaction and the ozone oxidation reaction are completed, is removed.

### TECHNICAL FIELD

The present invention relates to a method and apparatus for eliminating stench from polluted air and processing volatile organic compounds, and more particularly, to a method and apparatus for processing a polluted air through a photo-oxidation reaction using a TiO₂-based photocatalyst and an ozone oxidation reaction using a UV-lamp.

### BACKGROUND ART

Generally, air discharged from various industrial facilities or commercial facilities such as restaurant, etc., contains a severe stench and volatile organic compounds (VOC) harmful to human body and natural environments. Hence, the stench should be eliminated from the polluted air and the harmful volatile organic compounds should be processed into harmless substance using an apparatus capable of processing the harmful substances. Thereafter, the eliminated stench and the transformed volatile organic compounds should be discharged into the air.

Conventional apparatus for processing the polluted air are using an adsorptive method by active carbon or an oxidation adsorption method. However, these conventional apparatus have disadvantages such as a large volume and size, high maintenance and repair costs, and unsatisfactory processing results.

To this ends, “Bio Climatic” company in Germany developed an apparatus for eliminating stench and processing volatile organic compounds from a polluted air. FIG. 1 shows a constitution of the apparatus developed by “Bio Climatic” company.

Referring to FIG. 1, the apparatus includes a polluted air inlet port 1, a preprocessing chamber 5 provided with a filter therein, for filtering dust particles from the polluted air, an oxidation reaction chamber 9 provided with an ozone generating UV lamp 7 installed crossed with a flow direction of the air, for processing stench and volatile organic compounds using a photooxidation reaction and an ozone oxidation reaction from the polluted air that has passed through the preprocessing chamber 5; an adsorptive chamber 13 provided with an adsorptive means 11 filled with carbon, for adsorption-processing substances that were not processed in the air that had passed the oxidation reaction chamber 9, and an air discharge port 15.

In the conventional processing apparatus of polluted air, the polluted air is filtered and thereby dust particles are eliminated from the polluted air while the polluted air passes through the preprocessing chamber S. After that, the stench and the volatile organic compounds in the polluted air are dissolved and oxidized while the polluted air passes through the oxidation reaction chamber 9. Thereafter, a remaining harmful substance is adsorption-processed and is then discharged.

However, the photooxidation reaction and the ozone oxidation reaction using the UV lamp alone has a processing efficiency capable of processing only an approximately 8-9% of the stench and the volatile organic compounds. Thus, in order to eliminate a harmful substance that was not processed by the photooxidation reaction and the ozone oxidation reaction, the apparatus essentially includes the adsorptive chamber 13 capable of carrying out a carbon-adsorptive treatment.

Also, since this system follows the old methods, it has several drawbacks in that its use is inconvenient, the processing efficiency is very low, the adsorptive means 11 should be exchanged by two months to three months and thereby maintenance and repair costs are elevated, etc.

### DISCLOSURE OF THE INVENTION

Accordingly, it is an object of the invention to resolve the aforementioned problems and to provide method and apparatus for processing a polluted air, capable of maximizing efficiencies of the photooxidation reaction and the ozone oxidation reaction using a photocatalyst.

Another object of the present invention is to provide method and apparatus of a polluted air capable of enhancing the processing efficiencies of stench and volatile organic compounds in the photooxidation reaction and the ozone oxidation reaction and that does not need a following carbon adsorption processing.

Still another object of the present invention is to provide method and apparatus of a polluted air, capable of effectively processing ozone remaining after a photooxidation reaction and an ozone oxidation reaction are carried out.

To accomplish the above objects, there is a provided a method for processing stench and volatile organic compounds from a polluted air. The method comprises: a preprocessing step of removing dust particles from the polluted air; an ozone processing step of processing the stench of the polluted air and the volatile organic compounds through a photooxidation reaction and an ozone oxidation reaction using an ozone generating UV lamp and a TiO₂-based photocatalyst; and a postprocessing step of removing a residual ozone remaining after the photooxidation reaction and the ozone oxidation reaction are completed.

According to another aspect of the present invention, there is provided an apparatus for processing stench and volatile organic compounds from a polluted air. The apparatus comprises: a polluted air inlet port; a preprocessing chamber communicating with one end of the polluted air inlet and provided with a filter therein, for filtering dust particles from the polluted air introduced through the polluted air inlet port; an oxidation reaction chamber communicating with an outlet port of the preprocessing chamber and provided with an ozone generating UV lamp and a TiO₂-based photocatalyst coated on a surface of the oxidation reaction chamber, for processing the stench of the polluted air and the volatile organic compounds which are introduced through the preprocessing chamber through a photooxidation reaction and an ozone oxidation reaction; a postprocessing chamber communicating an outlet port of the oxidation reaction chamber and provided with an ozone removing means, for eliminating a residual ozone from the air which is introduced through the oxidation reaction chamber; and an air discharge port connected to an outlet port of the postprocessing chamber.

Preferably, the filter of the preprocessing chamber comprises a first filter for filtering dust from the polluted air and a second filter having fine particles and for filtering fine dust.

Further, the oxidation reaction chamber may have various constitutions according to use, function, and feature of an installing place.

Selectively, the oxidation reaction chamber has multiple cells which are divided along a flow direction of the polluted air, the ozone generating UV lamp is installed within the respective cells in a length direction of the cells, and the TiO₂-based photocatalyst is coated on inner surfaces of the respective cells.

Selectively, the oxidation reaction chamber has multiple guide plates coated with the TiO₂-based photocatalyst, the guide plates are arranged with a slope with respect to a flow direction of the air in multiple columns along vertical and horizontal directions, and the ozone generating UV lamp is multiple and the multiple ozone generating UV lamps are installed to vertically penetrate the guide plates.

Selectively, the oxidation reaction chamber has multiple partial shielding plates, wherein the partial shielding plates are arranged perpendicularly to a flow direction of the air such that only a part of the air flow is shielded, and the ozone generating UV lamp is multiple and the multiple ozone generating UV lamps are respectively installed between the partial shielding plates.

Selectively, the oxidation reaction chamber has multiple partition plates, wherein honeycomb type lattice frames coated with the TiO₂-based photocatalyst are installed on surfaces of the partition plates in a multi-stage with a constant interval therebetween, and wherein the ozone generating UV lamp is multiple and the multiple ozone generating UV lamps are respectively installed between the respective lattice frames.

Preferably, the surfaces on which the TiO₂-based photocatalyst is coated are embossing-treated or are made to have variously shaped protrusions.

Preferably, the ozone removing means of the postprocessing chamber is formed in a tray type in which at least one plate filled with an ozone reaction catalyst is slantingly arranged.

Selectively, the ozone removing means of the postprocessing chamber is in a honeycomb shape having partition plates crossing an inside of the postprocessing chamber to form multiple cells and is filled with an ozone reaction catalyst.

At this time, the ozone reaction catalyst contains MnO₂ but is not limited to MnO₂ alone.

Also, the ozone removing means of the postprocessing chamber comprises: multiple guide plates on which a TiO₂-based photocatalyst is coated, the multiple guide plates being slantingly arranged in multiple columns in horizontal and vertical directions; and multiple UV lamps installed to vertically penetrate the guide plates and which do not generate ozone.

### BRIEF DESCRIPTION OF THE DRAWINGS

The above object, other features and advantages of the present invention will become more apparent by describing the preferred embodiment thereof with reference to the accompanying drawings, in which:

FIG. 1 is a front sectional view of an apparatus for processing stench and volatile organic compounds from a polluted air in accordance with the conventional art;

FIG. 2 is a front sectional view of an apparatus for processing stench and volatile organic compounds from a polluted air in accordance with a first embodiment of the present invention;

FIG. 3 is a perspective view of a photocatalyst reaction chamber in the apparatus of FIG. 2;

FIG. 4 is a front sectional view of an apparatus for processing stench and volatile organic compounds from a polluted air in accordance with a second embodiment of the present invention;

FIG. 5 is a side sectional view of a postprocessing chamber in the apparatus of FIG. 4;

FIG. 6 is a front sectional view of an apparatus for processing stench and volatile organic compounds from a polluted air in accordance with a third embodiment of the present invention;

FIG. 7 is a cross-sectional view of the apparatus shown in FIG. 6;

FIG. 8 is a front sectional view of an apparatus for processing stench and volatile organic compounds from a polluted air in accordance with a fourth embodiment of the present invention;

FIG. 9 is a front sectional view of an apparatus for processing stench and volatile organic compounds from a polluted air in accordance with a fifth embodiment of the present invention;

FIG. 10 is a front sectional view of an apparatus for processing stench and volatile organic compounds from a polluted air in accordance with a sixth embodiment of the present invention;

FIG. 11 is a cross-sectional view of the apparatus shown in FIG. 10;

FIG. 12 a front sectional view of an apparatus for processing stench and volatile organic compounds from a polluted air in accordance with a seventh embodiment of the present invention;

FIG. 13 is a front sectional view of an apparatus for processing stench and volatile organic compounds from a polluted air in accordance with an eighth embodiment of the present invention;

FIG. 14A is a cross-sectional view of the apparatus shown in FIG. 13 and FIG. 14B is a side sectional view of the apparatus shown in FIG. 13; and

FIG. 15 is a front sectional view of an apparatus for processing stench and volatile organic compounds from a polluted air in accordance with a ninth embodiment of the present invention.

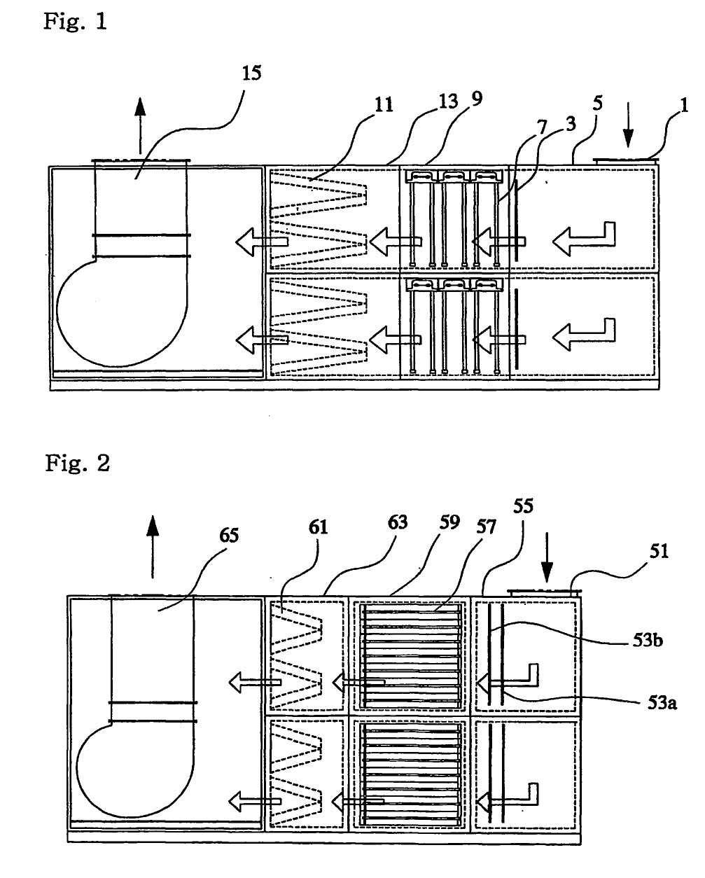

### BEST MODE FOR CARRYING OUT THE INVENTION

Now, preferred embodiments of the present invention will be described in detail with reference to the annexed drawings.

FIG. 2 is a simplified sectional view of an apparatus for processing stench and volatile organic compounds from a polluted air in accordance with a first embodiment of the present invention.

Referring to FIG. 2, there is arranged a preprocessing chamber 55 at one end of a polluted air inlet port 51. The preprocessing chamber 55 communicates with one end of the polluted air inlet 51 and is provided with filters 53a and 53b therein. Dust particles are filtered from the polluted air introduced through the polluted air inlet port 51 by passing through the preprocessing chamber 55. As shown in FIG. 2, the filters 53a and 53b can be made in a dual structure. Preferably, a first filter 53a has filtering particles capable of filtering a conventional sized dust particle and a second filter 53b has filtering particles capable of filtering a fine sized dust particle having a smaller diameter than the conventional sized dust particle. This filter structure enhances a physical purification efficiency prior to a chemical treatment.

An oxidation reaction chamber 59 is connected with an outlet port of the preprocessing chamber 55. The oxidation reaction chamber 59 is provided with an ozone generating UV lamp 57 and a TiO₂-based photocatalyst (not shown) coated on an inner surface of the oxidation reaction chamber. The oxidation reaction chamber 59 processes the stench of the polluted air and the volatile organic compounds which are introduced through the preprocessing chamber 55, using a photooxidation reaction and an ozone oxidation reaction. At this time, efficiency of the photooxidation reaction generated by the ozone generating UV lamp 57 is enhanced 10 times by the action of the TiO₂-based photocatalyst

In other words, through the photooxidation reaction and the ozone oxidation reaction, the volatile organic compounds (VOC) and the stench generating substances are oxidation-dissolved and thereby they are transformed into harmless oxygen, carbon dioxide, or water.

The ozone generating UV lamp 57 is multiple and the multiple ozone generating UV lamps 57 are preferably installed parallel to a flow direction of the air. This structure holds a contact with a reaction component long, which is generated by the ozone generating UV lamps 57, to thereby enhance the reaction efficiency. Thus, the use of the ozone generating UV lamps 57 provides an advantage in that the more amount of polluted air is purified within the shorter time. Especially, for the purpose of the enhancement in the reaction efficiency, the oxidation reaction chamber 59 is preferably constituted as shown in FIG. 3. In other words, the oxidation reaction chamber 59 has multiple cells 58 which are arrange along the flow direction of the polluted air. The ozone generating UV lamps 57 are respectively installed within the respective cells 58 in a length direction of the cells 58. The TiO₂-based photocatalyst is coated on inner surfaces of the respective cells 58. This structure decreases space and area occupied by the apparatus and enhances the processing efficiency, so that it allows the apparatus of the present invention to be applied to various fields such as an industrial large capacity polluted air processing and a small capacity polluted air processing like that in restaurants.

Also, in the oxidation reaction chamber 59, the surfaces on which the TiO₂-based photocatalyst is coated are embossing-treated or can be made to have variously shaped protrusions.

Again referring to FIG. 2, a postprocessing chamber 63 is connected with an outlet port of the oxidation reaction chamber 59. The postprocessing chamber 63 is also provided with an ozone removing means 61 for eliminating a residual ozone from the air which is introduced through the oxidation reaction chamber 59. The ozone removing means 61 of the postprocessing chamber 63 is formed in a tray type in which at least one plate 61 filled with an ozone reaction catalyst (not shown) containing MnO₂ is slantingly arranged.

In other words, unreacted ozone component remains in the air which has passed through the oxidation reaction chamber 59. This residual ozone reacts with the ozone reaction catalyst in the postprocessing chamber 63 and is transformed into oxygen. The following chemical formula 1 shows a reaction between the ozone reaction catalyst and MnO₂ as one example.

[Chemical Formula 1]

2MnO₂+5O₃→Mn₂O₇+6O₂

An air discharge port 65 is connected to an outlet port of the postprocessing chamber 63 to discharge the purified air into the outside.

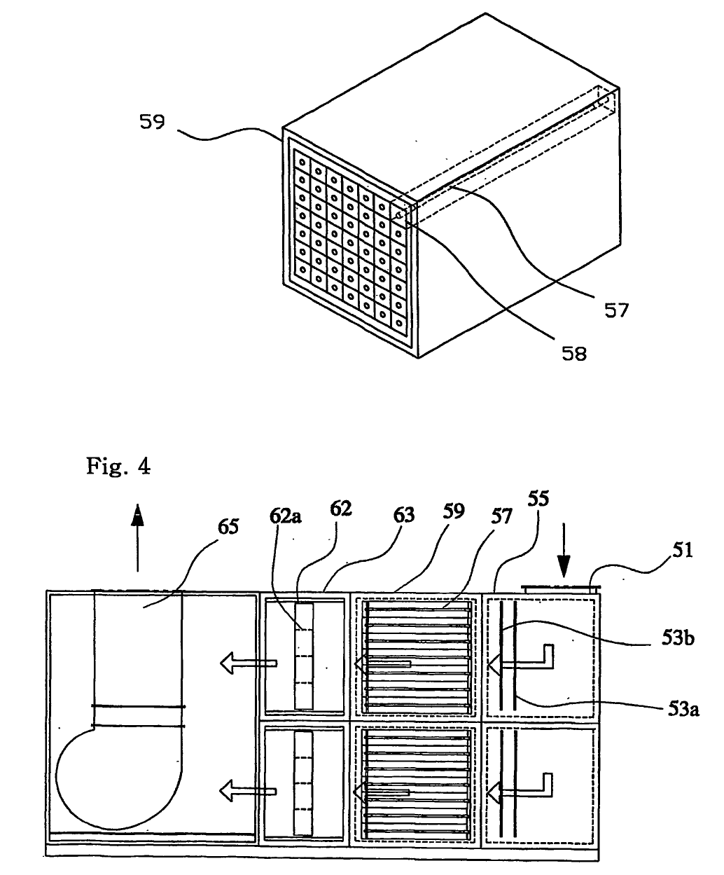

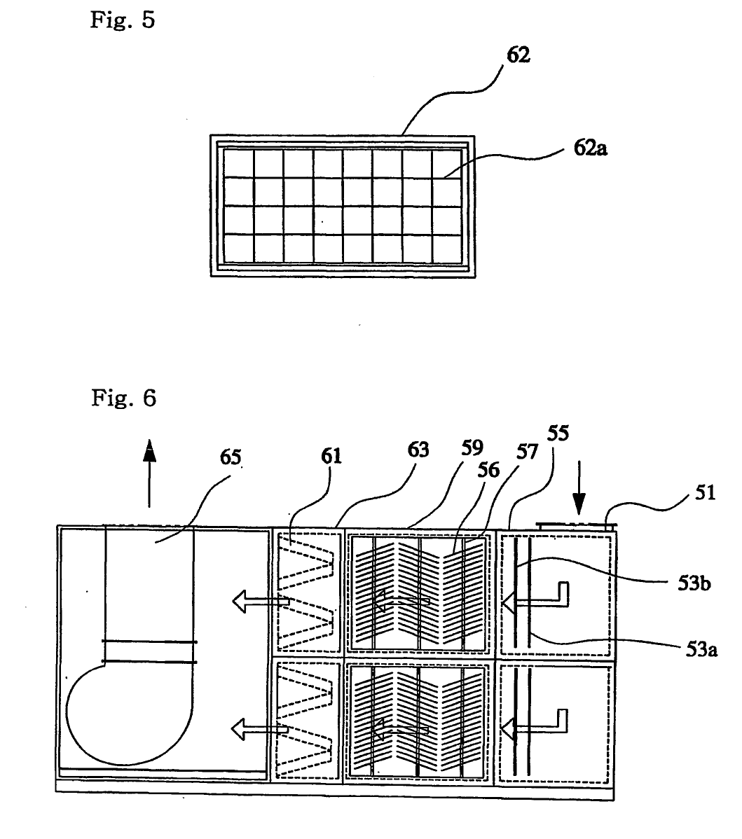

FIG. 4 shows a constitution of an apparatus for processing the stench and volatile organic compounds in accordance with a second embodiment of the present invention. As shown in FIG. 4, the apparatus is provided with an ozone removing means 62. The ozone removing means 62 is filled with an ozone reaction catalyst and has a honeycomb shape.

In other words, as shown in a side sectional view of FIG. 5, the ozone removing means 62 has multiple partition plates 62a which cross the inside thereof in horizontal and vertical directions. This constitution has disadvantages such as increase in the production costs and weak durability compared with the tray type plate 61 of the first embodiment. However, since this constitution has a high system stability during its operation and enables to enhance the processing efficiency, it may be advantageous according to its use.

FIG. 6 is a front sectional view of an apparatus for processing stench and volatile organic compounds from a polluted air in accordance with a third embodiment of the present invention. Like the apparatus of the first embodiment, a preprocessing chamber 55 is connected to one end of a polluted air inlet port 51 and filters 53a and 53b are arranged crossed with a flow direction of the air within the preprocessing chamber 55. A polluted air introduced through the polluted air inlet port 51 is filtered to eliminate dust particles while passing through the filters 53a and 53b.

An oxidation reaction chamber 59 is connected with an outlet port of the preprocessing chamber 55. The oxidation reaction chamber 59 is provided with multiple guide plates 56 inclined with a slope with respect to a flow direction of the air in multiple columns along vertical and horizontal directions, whereby a mixing effect of the polluted air is generated, a staying time of the polluted air is extended, and a contact area with the photocatalyst is enlarged to enhance the processing efficiency.

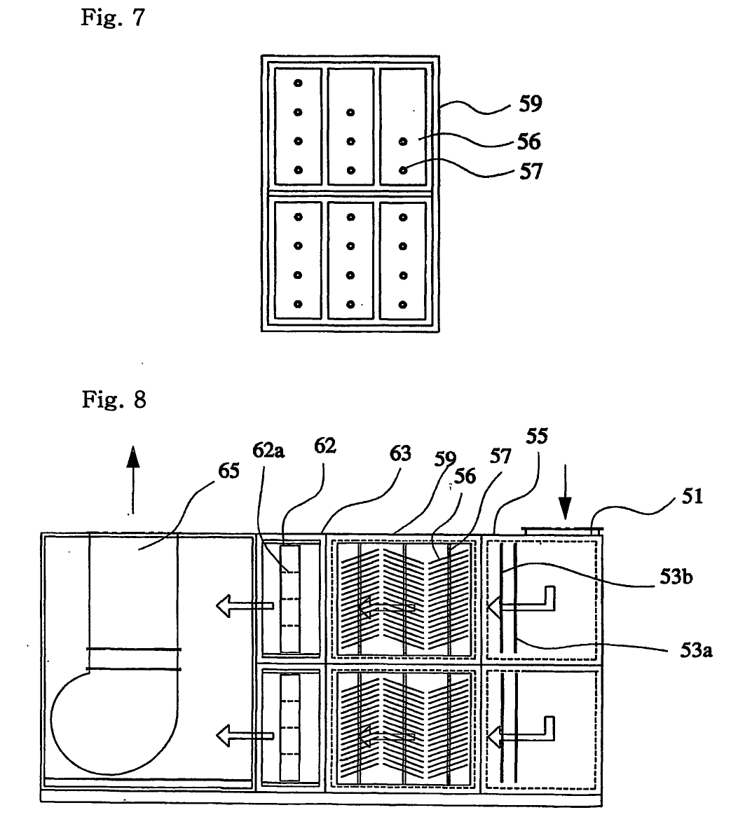

Multiple ozone generating UV lamps 57 are installed to vertically penetrate the guide plates 56. FIG. 7 is a cross-sectional view of the oxidation reaction chamber 59 of FIG. 6. TiO₂-based photocatalyst (not shown) is coated on the respective guide plates 56.

In other words, since a flow path of the air is extended by the guide plates 56, a reaction time is also extended, thereby decreasing an installing area, enhancing the processing efficiency and enabling to perform an effective processing with the less number of UV lamps.

Thus, through the photooxidation reaction and the ozone oxidation reaction within the above constituted oxidation reaction chamber, the volatile organic compounds (VOC) and the stench generating substances are oxidation-dissolved and thereby they are transformed into harmless oxygen, carbon dioxide, or water.

In the present embodiment, the guide plates 56 are arranged in three columns but they may be arranged in columns less than the three columns or columns greater than the three columns if necessary. Also, length and width of the guide plates columns may be altered if necessary.

Further, in the oxidation reaction chamber 59 of the present embodiment, the surface on which the TiO₂-based photocatalyst is coated may be embossing-treated to have more larger contact area or be made to have various shaped protrusions.

Again referring to FIG. 6, a postprocessing chamber 63 is connected with an outlet port of the oxidation reaction chamber 59. The postprocessing chamber 63 is also provided with an ozone removing means 61. In the present embodiment, the ozone removing means 61 of the postprocessing chamber 63 is formed in a tray type in which at least one plate 61 filled with an ozone reaction catalyst (not shown) containing MnO₂ is slantingly arranged like that of the first embodiment.

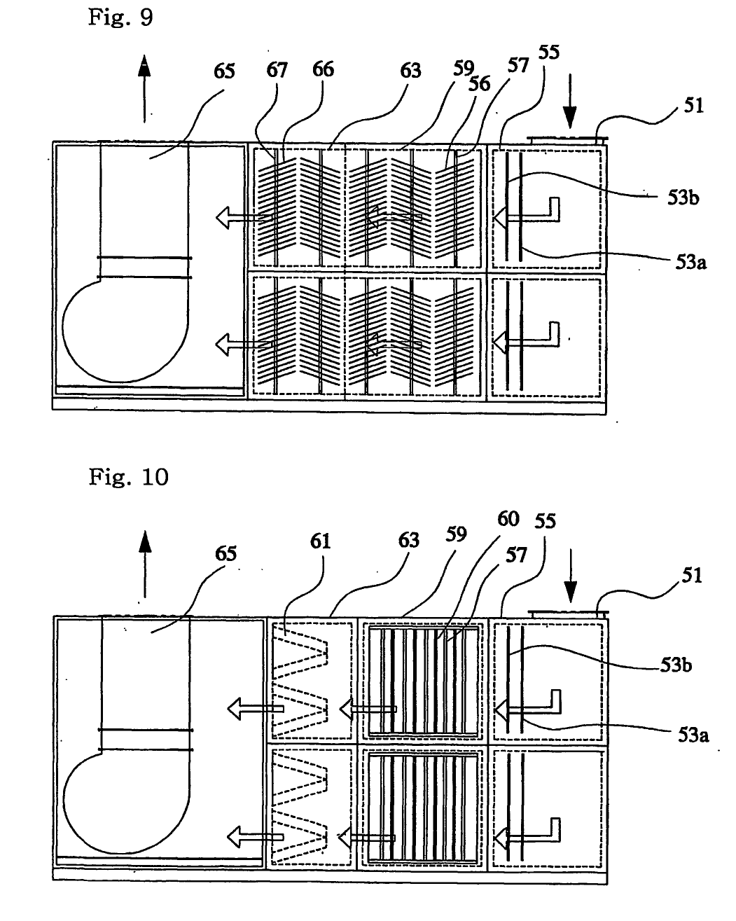

FIG. 8 is a front sectional view of an apparatus for processing stench and volatile organic compounds from a polluted air in accordance with a fourth embodiment of the present invention As shown in FIG. 8, a photooxidation chamber 55 has the same constitution as the photooxidation chamber of the third embodiment and an ozone removing means 62 of a postprocessing chamber 63 is made in the honeycomb structure filled with the ozone reaction catalyst like that of the second embodiment

FIG. 9 is a front sectional view of an apparatus for processing stench and volatile organic compounds from a polluted air in accordance with a fifth embodiment of the present invention. As shown in FIG. 9, a photooxidation chamber 55 has the same constitution as the photooxidation chamber of the third embodiment and an ozone removing means 62 of a postprocessing chamber 63 the ozone removing means 61 of the postprocessing chamber 63 includes multiple guide plates 66 inclined with a slope with respect to a flow direction of the air in multiple columns along vertical and horizontal directions, and multiple UV lamps 67 which do not generate ozone and are installed to vertically penetrate the guide plates 66, like that in the oxidation reaction chamber 59 mentioned in the third embodiment.

Here, it is noted that the UV lamp 67 used in the present embodiment is not the ozone generating lamp but a general UV lamp. In other words, according to the present embodiment, the photooxidation reaction and ozone oxidation reaction are generated even at the postprocessing chamber 63. However, since ozone is not generated from the lamp 67, ozone remaining after passing through the oxidation reaction chamber 59 is reacted. Accordingly, a residual ozone can be removed through ozone oxidation reaction using the oxidation reaction chamber 59 alone without using an ozone removing means having a different constitution in the postprocessing chamber 63. In addition, since photooxidation reaction and ozone oxidation reaction using TiO₂-based photocatalyst is generated even in the postprocessing chamber 63, there is obtained a dual effect in that the stench and the volatile organic compounds can be reprocessed.

In constituting the postprocessing chamber 63 like the above, guide plates 66 may be arranged in columns less or greater than the two columns shown in FIG. 9, if necessary. Also, length and width of the guide plates columns may be altered if necessary.

FIG. 10 is a front sectional view of an apparatus for processing stench and volatile organic compounds from a polluted air in accordance with a sixth embodiment of the present invention. Like the apparatus of the first embodiment, a preprocessing chamber 55 is connected to one end of a polluted air inlet port 51 and filters 53a and 53b are arranged crossed with a flow direction of the air within the preprocessing chamber 55. A polluted air introduced through the polluted air inlet port 51 is filtered to eliminate dust particles while passing through the filters 53a and 53b.

An oxidation reaction chamber 59 is connected with an outlet port of the preprocessing chamber 55. The oxidation reaction chamber 59 is provided with multiple partial shielding plates 60 installed perpendicularly to a flow direction of the air. The respective partial shielding plates 60 are installed in an alternatively leaned structure to an upper surface and a lower surface of the oxidation reaction chamber 59. An ozone generating UV lamp 57 is installed between the partial shielding plates 60.

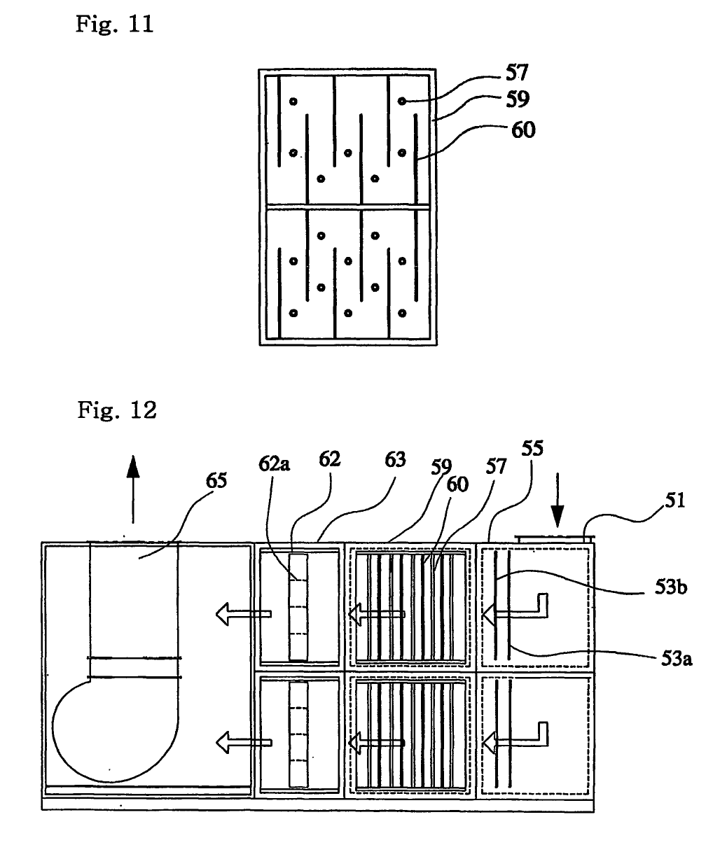

FIG. 11 is a cross-sectional view of the oxidation reaction chamber 59. TiO₂-based photocatalyst (not shown) is coated on the respective partial shielding plates 60.

As shown in FIG. 11, since one of the partial shielding plates 60 partially shields a flow of the air and changes a flow direction of the air. A rear partial shielding plate which is leaned to the other end opposite to one end of the prior partial shielding plate changes the flow direction of the air again. Thus, the flow path is extended by the multiple partial shielding plates 60, a staying time during which the air stays in the oxidation reaction chamber 59 is also extended and thereby the photooxidation reaction time and the ozone reaction time is extended.

The number of the partial shielding plates 60 may be increased or decreased to decrease an installing area and enhance the processing efficiency if necessary.

Further, a surface of the partial shielding plate on which the TiO₂-based photocatalyst is coated may be embossing-treated to have more larger contact area, be made to have various shaped protrusions, or be partially punched to decrease a pressure loss.

Thus, through the photooxidation reaction, the volatile organic compounds (VOC) and the stench generating substances are oxidation-dissolved and thereby they are transformed into harmless oxygen, carbon dioxide, or water.

Again referring to FIG. 10, a postprocessing chamber 63 is connected with an outlet port of the oxidation reaction chamber 59. The postprocessing chamber 63 is also provided with an ozone removing means 61. In the present embodiment, the ozone removing means 61 is formed in a tray type in which at least one plate 61 filled with an ozone reaction catalyst (not shown) containing MnO₂ is slantingly arranged like that of the first embodiment.

FIG. 12 a front sectional view of an apparatus for processing stench and volatile organic compounds from a polluted air in accordance with a seventh embodiment of the present invention. As shown in FIG. 12, a photooxidation chamber 55 has the same constitution as the photooxidation chamber of the sixth embodiment and an ozone removing means 62 of a postprocessing chamber 63 is made in the honeycomb structure filled with the ozone reaction catalyst like that of the second embodiment.

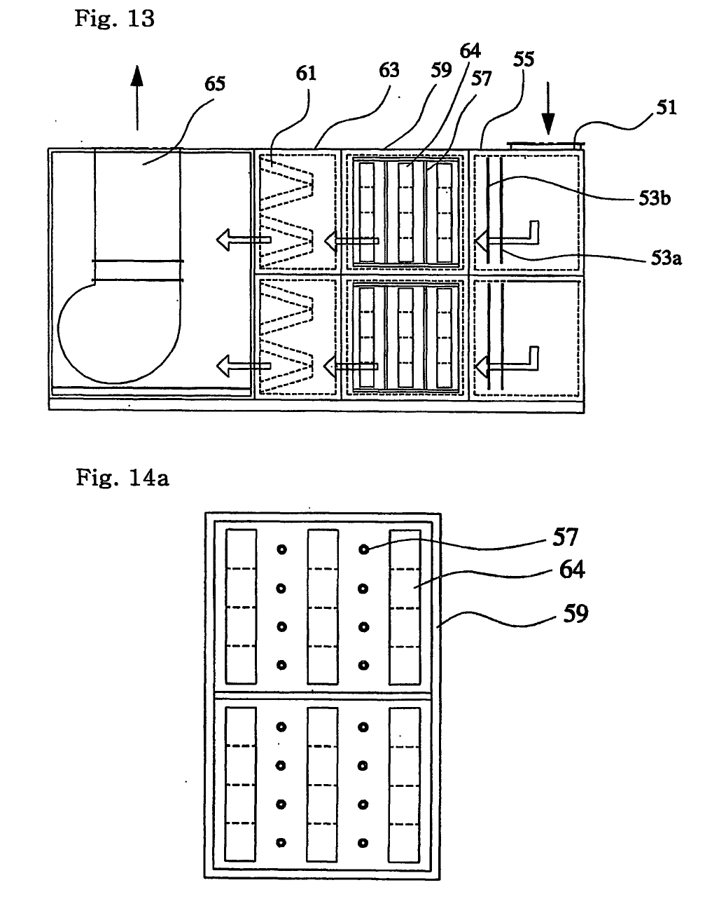

FIG. 13 is a front sectional view of an apparatus for processing stench and volatile organic compounds from a polluted air in accordance with an eighth embodiment of the present invention. Like the apparatus of the first embodiment, a preprocessing chamber 55 is connected to one end of a polluted air inlet port 51 and filters 53a and 53b are arranged crossed with a flow direction of the air within the preprocessing chamber 55. A polluted air introduced through the polluted air inlet port 51 is filtered to eliminate dust particles while passing through the filters 53a and 53b. An oxidation reaction chamber 59 is connected with an outlet port of the preprocessing chamber 55. The oxidation reaction chamber 59 is provided with a honeycomb type lattice frame 64 installed perpendicularly to a flow direction of the air. The honeycomb type lattice frame 64 is multiple and they are installed in a multi-stage structure with a constant interval between them. An ozone generating UV lamp 57 is installed between the lattice frames 64.

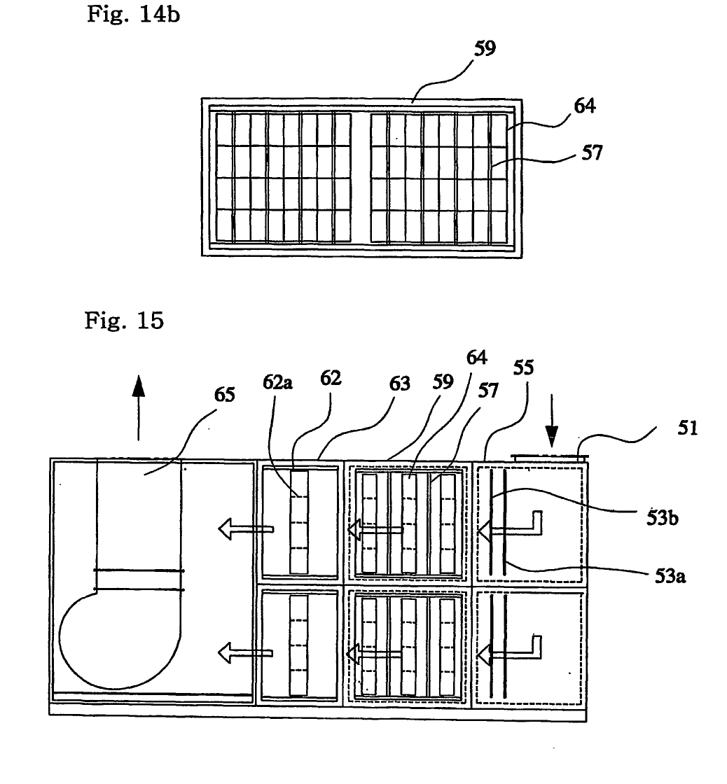

FIG. 14A is a cross-sectional view of the apparatus shown in FIG. 13 and FIG. 14B is a side sectional view of the apparatus shown in FIG. 13. TiO₂-based photocatalyst (not shown) is coated on inner surfaces of the cells of the respective honeycomb type lattice frames 64.

As shown in FIGS. 13, 14A and 14B, the constitution of the oxidation reaction chamber 59 in which the multi-staged honeycomb type lattice frames 64 coated with the TiO₂-based photocatalyst are orderly arranged allows a coated area and a contact area of the TiO₂-based photocatalyst to be enlarged during the photooxidation reaction taken place by the UV lamps 57, to thereby help more effective catalysis.

The interval between the honeycomb type lattice frames 64 can be varied to control an action area of the TiO₂-based photocatalyst, if necessary. Also, the number of the orderly arranged lattice frames 64 can be varied if necessary. Hence, it becomes possible to enhance the processing efficiency regardless of the installing area Further, a surface of the lattice frame 64 on which the TiO₂-based photocatalyst is coated may be embossing-treated to have more larger contact area, or be made to have various shaped protrusions.

Thus, through the photooxidation reaction, the volatile organic compounds (VOC) and the stench generating substances are oxidation-dissolved and thereby they are transformed into harmless oxygen, carbon dioxide, or water.

Again referring to FIG. 13, a postprocessing chamber 63 is connected with an outlet port of the oxidation reaction chamber 59. The postprocessing chamber 63 is also provided with an ozone removing means 61. In the present embodiment, the ozone removing means 61 of the postprocessing chamber 63 is formed in a tray type in which at least one plate 61 filled with an ozone reaction catalyst (not shown) containing MnO₂ is slantingly arranged lice that of the first embodiment.

FIG. 15 is a front sectional view of an apparatus for processing stench and volatile organic compounds from a polluted air in accordance with a ninth embodiment of the present invention. As shown in FIG. 15, a photooxidation chamber 55 has the same constitution as the photooxidation chamber of the eigth embodiment and an ozone removing means 62 of a postprocessing chamber 63 is made in the honeycomb structure filled with the ozone reaction catalyst like that of the second embodiment.

Thus, according to the present invention having the aforementioned various modifications, dust particles and fine dust particles are physically filtered from the polluted air introduced through the polluted air inlet port 51 by passing through the filters 53a and 53b of the preprocessing chamber 55. Thereafter, stench of the polluted air and volatile organic compounds are dissolved by a photooxidation reaction and ozone oxidation reaction between the UV and oxygen-based active group and between the UV and oxygen-based ion by passing through the oxidation reaction chamber 59. At this time, the efficiency of the photooxidation reaction is enhanced by actions of the inside of the oxidation reaction chamber 59 or means provided within the oxidation reaction chamber 59, for instance, cells, guide plates, partial shielding plates, and TiO₂-based photocatalyst coated on the surface of the honeycomb type lattice frame and thereby the volatile organic compounds are transformed into harmless carbon dioxide and water.

Thus, it can be confirmed that a decomposition efficiency from organic substance to inorganic substance using the TiO₂-based photocatalyst in the oxidation reaction chamber 59 is considerably enhanced compared with that in the oxidation reaction chamber of the conventional art. According to performance test results (cases of spraying painting for an automobile and discharge air current generated during the gloss processing of a coated film), it is confirmed that only 7-8% of total weight of volatile organic compounds as introduced is processed at the conventional apparatus while 80 wt/o or more of the volatile organic compounds and 90% of the stench are processed at the apparatus of the present invention.

Thus, since the oxidation reaction chamber 59 of the apparatus in accordance with the present invention dissolves the stench and the volatile organic compounds into nearly harmless substances, the apparatus of the present invention does not need an adsorptive chamber which is essentially requested in the conventional apparatus. Accordingly, maintenance and repair are convenient and production costs are also decreased.

In addition, since the postprocessing chamber 63 provided with an ozone removing means is connected to an outlet port of the oxidation reaction chamber, a residual ozone is removed from the air which has passed through the oxidation reaction chamber 59 and is then discharged from the postprocessing chamber 63.

### INDUSTRIAL APPLICABILITY

As described above, since the method and apparatus of the present invention enhances the transformation efficiency from organic substance to inorganic substance using TiO₂-based photocatalyst during a photooxidation reaction and ozone oxidation reaction by UV lamps, they processes the polluted air without a carbon adsorption. This mechanism enables to enhance the processing efficiency of the stench and volatile organic compounds, make easy to maintain and repair the apparatus, and to save the costs.

In addition, the apparatus of the present invention decreases space and area occupied by the oxidation reaction chamber and enhances the processing efficiency, so that it has an advantage in that the apparatus of the present invention can be applied to various fields such as a large capacity polluted air processing for industry and a small capacity polluted air processing for restaurants.

While the present invention has been described in detail, it should be understood that various changes, substitutions and alterations can be made hereto without departing from the spirit and scope of the invention as defined by the appended claims.

1. A method for processing stench and volatile organic compounds from a polluted air, the method comprises:
a preprocessing step of removing dust particles from the polluted air;
an ozone processing step of processing the stench of the polluted air and the volatile organic compounds through a photooxidation reaction and an ozone oxidation reaction using an ozone generating UV lamp and a TiO₂-based photocatalyst; and
a postprocessing step of removing a residual ozone remaining after the photooxidation reaction and the ozone oxidation reaction are completed.

2. An apparatus for processing stench and volatile organic compounds from a polluted air, the apparatus comprises:
a polluted air inlet port;
a preprocessing chamber communicating with one end of the polluted air inlet and provided with a filter, for filtering dust particles from the polluted air introduced through the polluted air inlet port;
an oxidation reaction chamber communicating with an outlet port of the preprocessing chamber and provided with an ozone generating UV lamp therein and a TiO₂-based photocatalyst coated on a surface of the oxidation reaction chamber, for processing the stench of the polluted air and the volatile organic compounds which are introduced through the preprocessing chamber through a photooxidation reaction and an ozone oxidation reaction;
a postprocessing chamber communicating an outlet port of the oxidation reaction chamber and provided with an ozone removing means, for eliminating a residual ozone from the air which is introduced through the oxidation reaction chamber; and
an air discharge port connected to an outlet port of the postprocessing chamber.

3. The apparatus of claim 2, wherein the ozone generating UV lamp is multiple and the multiple ozone generating UV lamps are installed parallel to a flow direction of the air.

4. The apparatus of claim 2, wherein the oxidation reaction chamber has multiple cells which are divided along a flow direction of the polluted air, wherein the ozone generating UV lamp is installed within the respective cells in a length direction of the cells, and wherein the TiO₂-based photocatalyst is coated on inner surfaces of the respective cells.

5. The apparatus of claim 2, wherein the oxidation reaction chamber has multiple guide plates coated with the TiO₂-based photocatalyst, wherein the guide plates are arranged with a slope with respect to a flow direction of the air in multiple columns along vertical and horizontal directions, and wherein the ozone generating UV lamp is multiple and the multiple ozone generating UV lamps are installed to vertically penetrate the guide plates.

6. The apparatus of claim 2, wherein the oxidation reaction chamber has multiple partial shielding plates, wherein the partial shielding plates are arranged perpendicularly to a flow direction of the air such that only a part of the air flow is shielded, and wherein the ozone generating UV lamp is multiple and the multiple ozone generating UV lamps are respectively installed between the partial shielding plates.

7. The apparatus of claim 6, wherein the multiple partial shielding plates are punched to decrease loss in a contact pressure.

8. The apparatus of claim 2, wherein the oxidation reaction chamber has multiple partition plates, wherein honeycomb type lattice frames coated with the TiO₂-based photocatalyst are installed on surfaces of the partition plates in a multi-stage with a constant interval therebetween, and wherein the ozone generating UV lamp is multiple and the multiple ozone generating UV lamps are respectively installed between the respective lattice frames.

9. The apparatus of any one of claims 2-8, wherein the surfaces on which the TiO₂-based photocatalyst is coated are embossing-treated.

10. The apparatus of any one of claims 2-8, wherein the ozone removing means of the postprocessing chamber is formed in a tray type in which at least one plate filled with an ozone reaction catalyst is slantingly arranged.

11. The apparatus of any one of claims 2-8, wherein the ozone removing means of the postprocessing chamber is in a honeycomb shape having partition plates crossing an inside of the postprocessing chamber to form multiple cells and is filled with an ozone reaction catalyst.

12. The apparatus of claim 10 or 11, wherein the ozone reaction catalyst contains MnO².

13. The apparatus of any one of claims 2-8, wherein the ozone removing means of the postprocessing chamber comprises:
multiple guide plates on which a TiO₂-based photocatalyst is coated, the multiple guide plates being slantingly arranged in multiple columns in horizontal and vertical directions; and
multiple UV lamps installed to vertically penetrate the guide plates and which do not generate ozone.

14. The apparatus of any one of claims 2-8, wherein the filter of the preprocessing chamber comprises a first filter for filtering dust from the polluted air and a second filter having fine particles and for filtering fine dust.
